(19) United States
(12) Patent Application Publication
(10) Pub. No.: US 2011/0017409 A1
(43) Pub. Date: Jan. 27, 2011

(54) VERTICAL BLIND TIDY

(76) Inventor: Roy Houghton, Bristol (GB)

Correspondence Address: MARSHALL & MELHORN, LLC, FOUR SEAGATE - EIGHTH FLOOR, TOLEDO, OH, 43604, US

(21) Appl. No.: 12/735,165

(22) PCT Filed: Dec. 19, 2008
(86) PCT No.: PCT/GB2008/051214

§ 371 Date: Oct. 8, 2010

(51) Int. Cl. E06B 9/38

(52) U.S. Cl. 160/181

(57) ABSTRACT

A device for securing the louvres of a vertical blind is provided. The device comprises a base plate that is adapted for fixing to a surface adjacent the blind and an integral retaining member which is adjustable to releasably secure a variable number of louvres against the base plate.

The present invention relates to a vertical blind retaining device. In particular, the invention relates to a convenient device for holding the louvres of a vertical blind in a compressed position against the window or door frame or adjacent wall.

Vertical blinds are familiar fittings in residential and commercial buildings. Conventional vertical blinds generally comprise a plurality of slats (louvres) disposed vertically from a horizontal track. The track incorporates a mechanism which permits the blind to be drawn to an open position in which all of the vertical slats are stacked at one side of the blind (or half of the slats are stacked at one side of the blind and half at the other). The blind may also be drawn to a closed position in which all of the vertical slats are evenly spaced across the opening (e.g. window or glass door). When drawn to a closed position, the slats may be rotated in concert to a position in which they are parallel to the plane of whatever window or glass door they are installed near, thereby completely blocking the view through the window or glass door. Alternatively, they may be rotated to a position in which they are perpendicular to the plane of the window or door, thereby permitting light to enter through the window.

A common problem arises when the blind is drawn to the open position and the window or door with which the blind is associated is opened for ventilation. In this situation, a breeze blowing through the window or door rattles or flaps the blind. The resulting noise is irritating and distracting. In moderate breezes, flapping blinds may knock objects from nearby surfaces, causing inconvenience or breakage. The movement may cause the slats to become mis-aligned with respect to one another so as to require manual adjustment by the user. In more extreme cases, the traversing and rotating mechanism or the slats themselves may be damaged.

The inclusion of weights in the bottom end of each slat and the provision of cords strung along the bottom edge of the blind securing each slat to its neighbour at a fixed interval go some way to reducing the more extreme instances of wind-induced movement, but are far from offering a solution.

Curtains are an alternative form of window covering. Since each curtain is, in general, made from a single piece of fabric of heavier weight than the material used for blinds, the risk of curtains flapping in the breeze coming through an open window is not so great a problem as it is for vertical blinds. Nonetheless, it is known to gather a curtain which has been drawn back to an open position and tether same to the wall or window frame. This secures the curtain and also draws the curtain further away from the opening, allowing in more light and gathering the fabric in an aesthetically pleasing manner. Curtains are commonly tied back with a length of fabric or cord which is loosely passed around the curtain with both ends fixed to a hook secured to the wall or window frame. Fabric tie-backs could be applied to gather the slats of vertical blind drawn to the open position, but this has not proved popular, perhaps because such a tie-back is not very convenient in connection with vertical blinds, nor does it sit well with the more modern style and clean lines of a vertical blind.

U.S. Pat. No. 5,692,553, issued to Jensen, describes a vertical blind retaining device comprising a fixed bracket and a removable retaining plate. The device is used to secure the blind to window frame, in compressed position, when blind is drawn back (open). The device prevents the blind from restricting flow of light through the window. However, the fixed bracket is large and unsightly and protrudes far enough to catch on clothing or scratch people passing through an adjacent door. Moreover, the capacity of the device, i.e. of the number of slats it can retain effectively, is determined by the size of the bracket, which is fixed at the time of manufacture.

It is, therefore, an object of the present invention to provide a universal, convenient and smart device for securing the louvres of a vertical blind which is adjustable for optimal retention of blinds having different numbers of louvres.

Accordingly, the invention provides a device for securing the louvres of a vertical blind, comprising a base plate that is adapted for fixing to a surface adjacent the blind and an integral retaining member which is adjustable to releasably secure a variable number of louvres against the base plate.

The device provides a neat, effective and easy to use mechanism for gathering the louvres of a vertical blind, when drawn to the open position, and securing said louvres to the door or window frame or adjacent wall.

If the vertical blind is installed within a window or door recess, the device may be fixed to the vertical surface inside the recess i.e. perpendicular to the plane of the window or door. Alternatively, if the blind is installed within the room (i.e. the track from which the blind hangs is installed above the recess rather than within it), the device may be fixed to the wall adjacent to the window or door, parallel to the plane of the window or door.

The retaining member is integral with the base plate i.e. it is not intended to be removed in normal use. This makes for an easy to use device and avoids possible problems of storage and loss inherent with use of a retaining member that is completely removable from the base plate.

In use, the retaining member gathers the louvres together and secures them against the base plate.

In one embodiment, the integral retaining member is a flexible retaining member, the proximal end of which is fixed towards one end of the base plate, and the other end of the base plate is adapted to engage a distal part of the flexible retaining member such that the louvres are releasably secured against the base plate by the flexible retaining member.

A suitable flexible retaining member is a tape, band, cord or chain. Most preferably, the flexible retaining member is a ball chain. A suitable ball chain comprises a cord to which plastic balls are fixed at set intervals, as known e.g. for tethering together the bottom weights of the individual louvres of a vertical blind. Metal ball chains, as commonly used to control the angle of vertical blinds, comprising a chain of articulating metal ball/rod units are also suitable.

The base plate may be formed of any suitable material with regard to rigidity, weight, cost, ease of manufacture etc. Conveniently, the base plate is made of mild steel or of plastic.

One end of the flexible retaining member (“the proximal end”) is fixed towards one end of the base plate. The proximal end of the flexible retaining member is not designed to be detached from the base plate during normal use; in this respect, the flexible retaining member is integral to the base plate. The other end of the base plate is adapted to engage a distal part of the flexible retaining member such that, in use, the louvres are releasably secured against the base plate by the flexible retaining member. The means to engage the flexible retaining member are capable of acting on any point towards the free end of the flexible retaining member (“the distal part”) and thus permit the flexible retaining member to be drawn to the length appropriate to enclose and secure any given number of louvres.

The means for the base plate to releasably engage a distal part of the flexible retaining member will be specific to the nature of the flexible retaining member, i.e. the flexible retaining member and the base plate cooperate to provide a reversible engagement. For example, in a basic embodiment, the flexible retaining member is a simple cord and the base plate is provided with a tapering slot so that the cord can be passed into the slot and pulled into the taper until the sides of the slot are sufficiently narrow to grip the cord and prevent it from slipping through. In a preferred embodiment, the flexible retaining member is a ball chain and the base plate is provided with a parallel sided slot whose width is greater than the diameter of the cord but less than the diameter of the balls so that the cord can be passed into the slot at the desired point and will be prevented from slipping through the slot because the adjacent ball will not pass through. Other arrangements are readily envisaged, depending on the nature of the flexible retaining member. For example, if the flexible retaining member is a chain, the base plate may be provided with a hook.

Preferably, the distance between the location on the base plate where the proximal end of the retaining member is fixed and the location at which a distal part of the flexible retaining member engages is arranged to be slightly greater than the width of the louvres of the blind in order that the louvres can be secured flat against the base plate when the flexible retaining member is engaged.

The object of providing a device that is adaptable to securely retain vertical blinds comprising different numbers of louvres is achieved above by providing a flexible retaining member whose retaining length—the length between the fixed proximal end and the point at which the base plate engages a distal part of the member—is adjustable, i.e. may be varied by engaging the flexible retaining member at a different point towards its distal end. The same object may alternatively be achieved by providing a flexible retaining member formed of an elastic material wherein the distal end of the member engages with the base plate, e.g. by a loop on a hook, and the necessary variation in retaining length is provided by the elasticity of the material.

The retaining member may be biased towards the base plate in order to compress the louvres against the base plate thereby retaining them more securely. In the above-described embodiment utilising a flexible retaining member, this may be achieved by drawing the flexible retaining member tightly from its fixed, proximal end, around the louvres, to engage a distal part with the base plate, so that the louvres are compressed against the base plate by the tension in the flexible retaining member. This compressive force may be augmented by using a flexible retaining member formed of an elastic material. The compressive force exerted by the retaining member should be sufficient to prevent movement of the louvres relative to each other and to the base plate at the site of compression, but not so great as to permanently mark or otherwise damage the fabric of the louvres.

In another embodiment, the integral retaining member is a rigid retaining member biased towards the base plate and capable of releasably securing the louvres against the base plate.

The retaining member is biased towards the base plate such that the louvres are gathered and held against the base plate by the retaining member. Conveniently, the retaining element is an arm, pivotably mounted to the base plate towards one end. However, other arrangements may be envisioned.

The biasing force is sufficient to securely retain the louvres in the device when subjected to air currents moving through the open window or door. Preferably, the biasing force is provided by a spring, e.g. the retaining member is an arm, pivotably mounted to the base plate and biased towards the base plate by a spring, thus forming a spring-loaded clamp. The retaining member and/or the base plate may comprise ridged or textured areas or a pad of non-slip material in order to enhance the clamp's grip on the louvres while at the same time protecting them from damage.

The clamp is adapted to permit manual release of the louvres from the clamp. For example, manual force may be applied against the spring to release the hold of the retaining arm on the louvres. Conveniently, the retaining member comprises a lever wherein manual pressure on one end of the lever, against the action of the spring, causes the lever to rotate about the pivot, thereby releasing the grip of the other end of the lever (the retaining arm) on the louvres.

Optionally, the clamp can be provided with a releasable catch to lock the clamp in the closed (i.e. louvres secured) position.

It is possible that in certain vertical blind installations the device of the invention, in particular the clamp embodiment, while being ideal for securing the louvres when the blind is in the open position, may obstruct the free hanging of the louvre(s) adjacent to the clamp when the blind is closed. In particular, this may be an issue when the louvres are rotated to parallel with the plane of the window. The device of the invention may be adapted to solve this problem as well.

Thus, the device of the invention may further comprise a wall-mounting bracket which is adapted for fixing to a surface (e.g. window or door frame or adjacent wall), wherein the bracket and the base plate are adapted to co-operate such that the base plate is capable of being releasably mounted on the bracket.

For example, the base plate may be mounted on the wall-mounting bracket by magnetic attraction i.e. each part comprises a magnet (or one of the parts comprises a magnet and the other a metal capable of being magnetised), such that opposing surfaces of the two parts attract. Alternatively, opposing surfaces of the two parts may be provided with co-operating shapes, e.g. a dovetail slide, such that they can be locked together in releasable fashion. This two-piece arrangement permits the device to be in situ when needed to secure the louvres when the blind is in the open position, but allows it to be removed when not in use. The wall-mounting bracket is relatively discrete and reasonably flush to the wall compared to the complete clamp assembly and so does not foul the louvres when the blind is in the open position.

A second wall-mounting bracket may be fixed at a convenient location nearby to provide somewhere to store the clamp part when not in use.

Known vertical blind systems comprise control mechanisms for closing and opening the blinds and for adjusting the tilt of the louvres i.e. the angle of the louvres relative to the plane of the window. Generally, these controls are in the form of a pull-cord and a tilt control chain, respectively. Both cord and chain are in the form of long, continuous loops that hang down from the track at one end of the blind assembly. These lengths of cord and chain can become tangled, inconveniencing the user. More seriously, the loose cord/chain can present a potentially fatal strangulation hazard for individuals, e.g. young children or pets, who might get them caught around their necks.

The device of the invention can be readily adapted to additionally provide a means to keep the pull-cord and tilt control chain from getting tangled and hence reduce the risk of strangulation. Said adaptation further avoids any problem of the device or wall mounting bracket of the invention obstructing the pull cord or tilt control chain, which might otherwise occur when the device is situated at the same end of the blind as these controls.

Accordingly, the invention further provides a device as described above which is adapted to secure the pull-cord and/or tilt control chain.

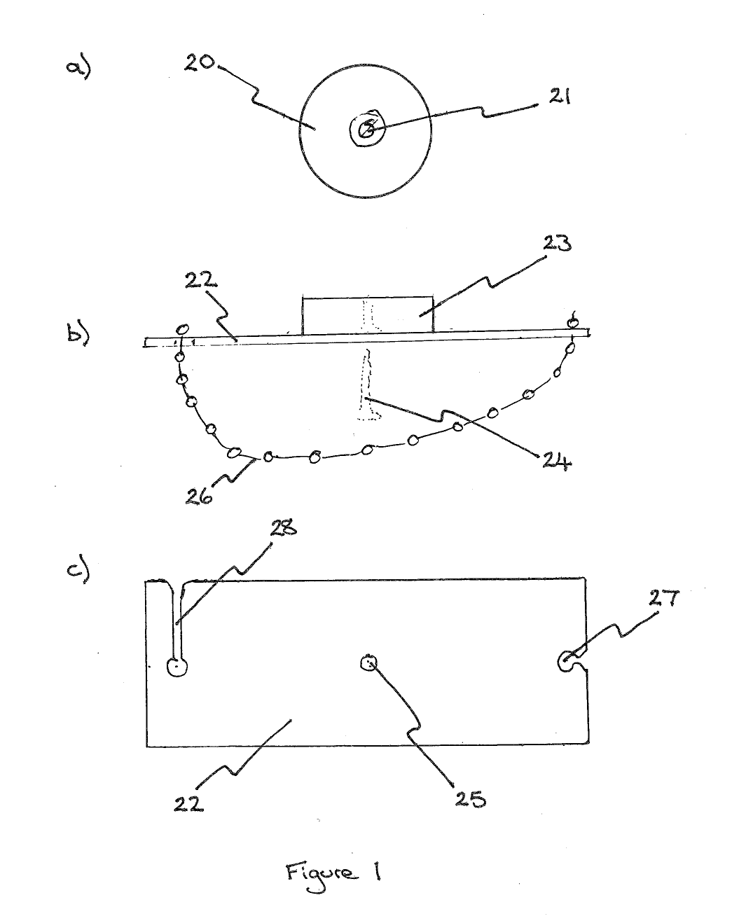

In a preferred embodiment, the device is adapted such that, in use, the pull cord and/or tilt control chain pass around a spacer disk on the back face of the base plate and are thereby secured between the base plate and the wall. Conveniently, a disk shaped magnet doubles as the means for mounting the base plate on the wall-mounting bracket and as the spacer disk, as illustrated in FIG. 1. The vertical location of the device on the wall or window/door frame relative to the length of the pull cord and/or tilt control chain is selected such that the cord and/or chain are held in tension by the spacer disk. In this way the cord/chain may be operated as normal, but are prevented from escaping, and thus presenting a strangulation hazard, by the base plate. Preferably, the diameter of the magnet/spacer is smaller than the height of the base plate: this prevents possible release of the cord/chain should the device accidentally be rotated on its mounting from horizontal orientation through vertical orientation. Preferably, both the pull-cord and the tilt control chain are secured by the vertical blind retaining device.

In an alternative anti-ligature embodiment, the wall-mounting bracket is adapted to provide channels to house the pull-cord and/or tilt control chain. The channels to house the cord and chain are conveniently provided by manufacturing the wall-mounting bracket in two halves, each half having channels on its surface, such that when the two halves of the wall mounting bracket are assembled and the respective surfaces are abutted, channels to contain the cord and chain are created. This construction also has the advantage that it can be fitted to cords/chains of existing blind installations without the need to break or cut the cord/chain or dismantle the assembly.

The invention further provides a method for releasably securing a variable number of louvres of a vertical blind which comprises providing a device as described herein, comprising a base plate and an adjustable integral retaining member, fixed to a surface adjacent the blind and securing said louvres against the base plate by the use of the adjustable integral retaining member.

The invention is illustrated by the following non-limiting example with reference to the appended figures, of which: —

FIG. 1 is a diagram showing a vertical blind-retaining device according to the invention, comprising a flexible retaining member: a) is a front view of a simple wall-mounting bracket (in this case, a magnet fixed to the wall); b) is a top view of a device according to the invention, comprising a base plate, a flexible retaining device (ball chain) and a magnet for mounting the device on the wall-mounted bracket; c) is a front view of the base plate (ball chain not shown).

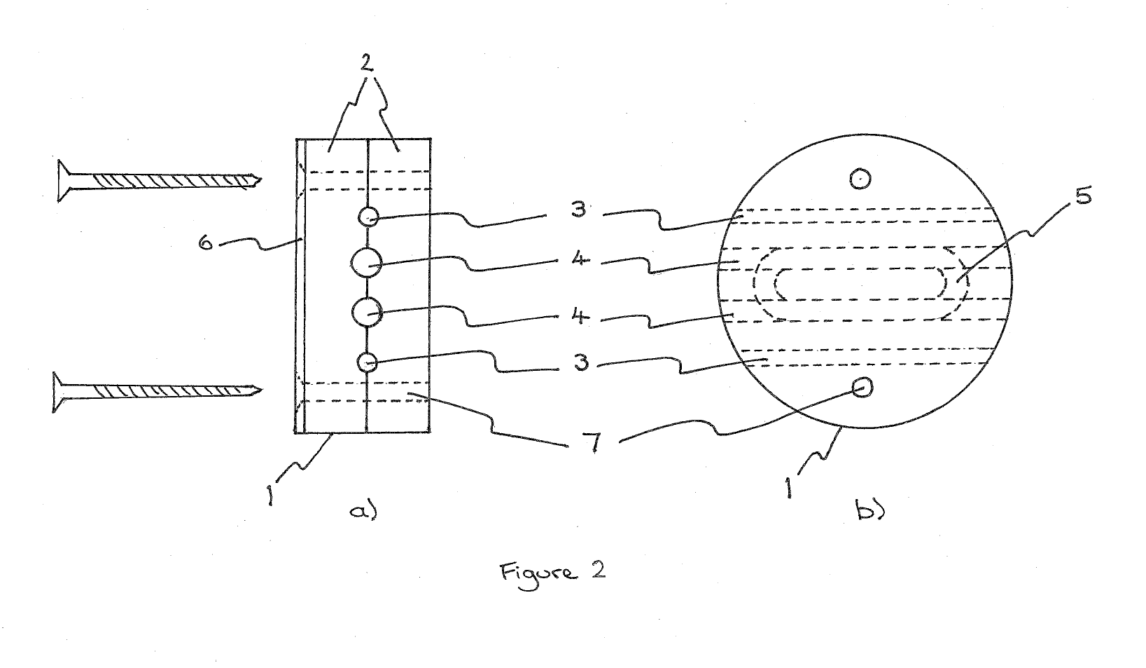

FIG. 2 is a diagram showing a wall-mounting bracket according to the invention: a) shows the bracket viewed from above; b) is a view from the side.

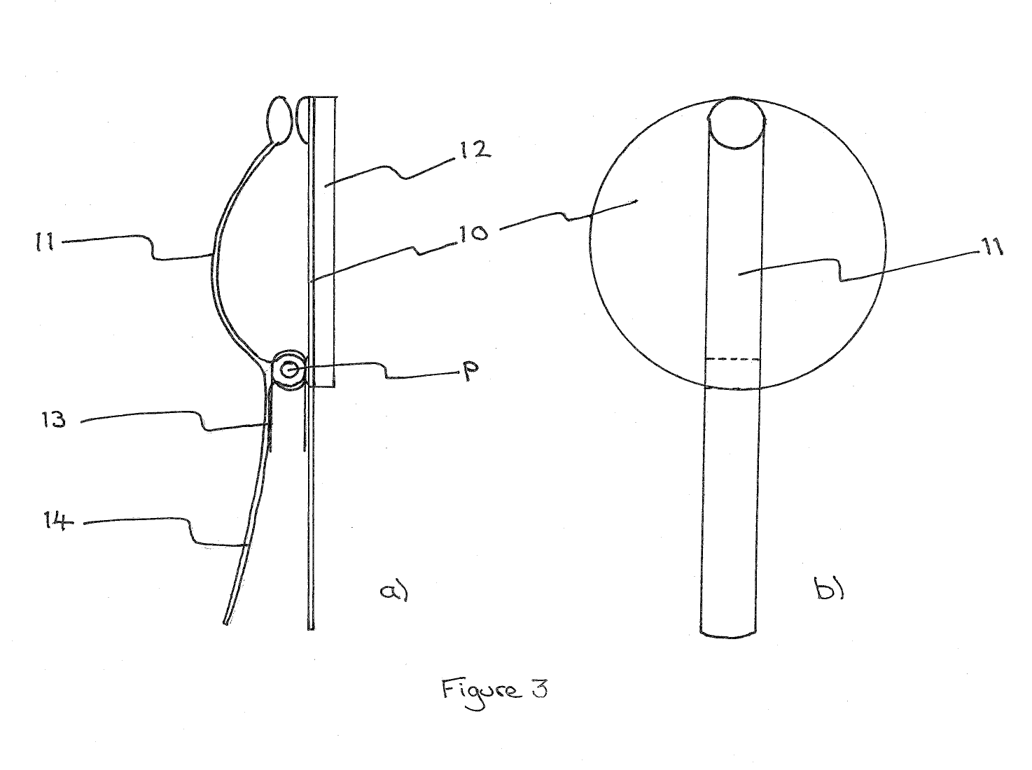

FIG. 3 is a diagram showing a clamp according to the invention: a) shows the clamp viewed from above; b) is a view from the side.

### EXAMPLE 1

A first embodiment of the invention, utilising a flexible retaining member, is illustrated in FIG. 1.

In this example, the wall-mounting bracket is a circular, disk-shaped magnet (20). The bracket is fixed to the wall, or window/door frame, by a screw (21) passing through a pre-drilled hole. The hole is countersunk so that the screw head does not protrude above the surface of the magnet.

Attached to the rear face of the base plate (22) is a second magnet (23), enabling the base plate to be mounted on the bracket by magnetic attraction between the two magnets. Either one of the magnets (20) and (23) may be substituted with a disk of metal (e.g. steel) that is capable of being magnetised. The base plate (22) itself may be made of metal (e.g. steel) that is capable of being magnetised, so that only one magnet is required in order to wall-mount the device by magnetic attraction. In some situations, it may not be necessary for the device to be removable, i.e. it may be acceptable for the device to be permanently fixed to the wall or window/door frame. In this case, the device may be fixed directly to the wall by a screw (24) passing through a hole (25) pre-drilled through the base plate (22) and the magnet (23); in this case, the magnet (23) serves only as a spacer and could be substituted with a non-magnetic material. Hence, a convenient multi-purpose device of the invention comprises a metallic base plate (22) and a disk-shaped magnet (23): if a removable device is required, the magnet is screwed to the wall or window/door frame and the base plate is mounted thereon by magnetic attraction; if the device is not required to be removable, both the base plate and the magnet can be fixed to the wall or window/door frame by a screw (24) through hole (25), the magnet acting as a spacer between the base plate and the wall or window/door frame.

In use, the pull-cord and/or tilt control chain of the vertical blind can be routed around the magnet/spacer (23) and thus secured behind the base plate (22). The diameter “d” of the magnet/spacer is smaller than the height “h” of the base plate, so that the cord/chain cannot be accidentally released if the base plate is rotated about fixing screw (24).

One end (“the proximal end”) of a ball chain (26) is fixed towards one end of the base plate by passing through hole (27) which has a restricted opening to allow the chain to be fitted on assembly of the device, but prevent accidental egress of the chain subsequently. The diameter of the round part of hole (27) is smaller than the diameter of the balls of the ball chain so that the ball chain cannot be pulled through the hole. Towards the other end of the base plate is a slot (28) capable of receiving a distal part of the ball chain. The dimensions of the slot are such that the ball chain, once placed therein, cannot be pulled through. The closed end of the slot may be shaped, as shown in FIG. 1 c) to hinder unintended egress of the ball chain from the slot, but at the same time permit it to be removed on demand. By providing a “hole” at the base of the slot whose diameter is slightly larger than the general width of the slot but smaller than the diameter of the balls, the ball immediately behind the base plate is pulled into the hole by the weight of the louvres, thus securing the ball chain at the base of the slot while also helping to prevent chafing of the cord. For clarity, the “free” portion of the ball chain which is distal to the slot is not shown in FIG. 1 b).

The dimensions of the vertical blind retaining device of the invention can be scaled to suit vertical blinds with louvres of different sizes. Blinds having louvres 3 inches (89 mm) or 5 inches (127 mm) wide are in common use. In one embodiment, the base plate is made from mild steel and is about 115 mm×40 mm×1.5 mm and the diameter of the magnet/spacer is about 32 mm (i.e. FIG. 1 is about life-size). This device is ideally suited to 89 mm blinds, although it will also accommodate 127 mm blinds.

### EXAMPLE 2

A second embodiment of the invention is exemplified by the bracket and clamp shown in FIGS. 2 and 3. The figures illustrate the specific embodiment which provides a separate wall-mounting bracket, itself providing channels to house the pull-cord and control chain.

In this example, the wall-mounting bracket is a circular, disk shape. Typically, the bracket might be approximately 50 mm in diameter and 20 mm thick, although the dimensions will vary according to the size of the clamp which is dependent on the dimensions of the louvres. The bracket (1) comprises two co-operating halves (2) which abut along the plane of the disk. When the two halves of the bracket are assembled, matching grooves in the opposing faces co-operate to provide separate channels (3) and (4) to house the pull-cord and the tilt control chain, respectively. The dimensions of the channels are tailored to provide a snug fit for the cord/chain which allows free movement without snagging. FIG. 2 b) illustrates the passage of the channels through the bracket. The downward and return channels for either cord may be connected by a channel (5) describing a semi-circular arc so that the end of the loop is within the bracket. In this embodiment, the tension of the cord may be controlled by the positioning of the bracket on the wall. Alternatively, the cord(s) may pass right through the bracket, looping back some distance below. In this example, the bracket also comprises a steel plate (6) on its outer face for affixing the magnet attached to the base plate of the clamp assembly. The bracket is attached to the wall by screws inserted in pre-drilled holes (7).

FIG. 3 shows a clamp comprising a base plate (10) and a retaining arm (11). A magnet (12) is attached to the base plate to enable the clamp to be releasably mounted on the wall-mounting bracket (1). The retaining arm is in the form of a spring-loaded clip which pivots about pivot (P) which is capable of securing a plurality of louvres between the retaining arm and the base plate. The retaining arm is biased towards the base plate by the spring (13). The retaining arm can be moved away from the base plate, and the louvres released, by the user depressing the lever (14).

1-13. (canceled)

14. A device for securing the louvres of a vertical blind, comprising a base plate that is adapted for fixing to a surface adjacent the blind and an integral retaining member which is adjustable to releasably secure a variable number of louvres against the base plate.

15. A device according to claim 14, wherein the integral retaining member is a flexible retaining member, the proximal end of which is fixed towards one end of the base plate, and the other end of the base plate is adapted to engage a distal part of the flexible retaining member such that the louvres are releasably secured against the base plate by the flexible retaining member.

16. A device according to claim 15, wherein the flexible retaining member is a ball chain.

17. A device according to claim 14, wherein the integral retaining member is biased towards the base plate.

18. A device according to claim 17, in which the retaining member is a spring actuated rigid member.

19. A device according to claim 14, further comprising a spacer on the back face of the base plate such that the device is capable of securing the pull-cord and/or tilt control chain between the base plate and the vertical surface adjacent the blind.

20. A device according to claim 19, wherein the spacer is disk-shaped.

21. A device according to claim 19, wherein the spacer is magnetic.

22. A device according to claim 14, further comprising a wall-mounting bracket which is adapted for fixing to a surface, wherein the bracket and the base plate are adapted to co-operate such that the base plate is capable of being releasably mounted on the bracket.

23. A device according to claim 22, in which the bracket and the base plate are magnetically attracted.

24. A device according to claim 22 in which the wall-mounting bracket provides channels to house the pull-cord and/or tilt control chain of the blind.

25. A method for releasably securing a variable number of louvres of a vertical blind which comprises providing a device according to claim 14 fixed to a surface adjacent the blind and securing said louvres against the base plate by the use of the adjustable integral retaining member.
